(19) United States
(12) Patent Application Publication
(10) Pub. No.: US 2025/0068918 A1
(43) Pub. Date: Feb. 27, 2025

(54) AUTOMATED TRAINING ON MASSIVE MULTITASK

(71) Applicant: International Business Machines Corporation, Armonk, NY (US)

(72) Inventors: Leshem Choshen, Jerusalem (IL); Elad Venezian, Binyamina (IL); Shachar Batya Don-Yehiya, Jerusalem (IL)

(21) Appl. No.: 18/454,124

(22) Filed: Aug. 23, 2023

(51) Int. Cl. G06N 3/091

(52) U.S. Cl. CPC G06N 3/091

(57) ABSTRACT

Various systems and methods are presented herein regarding configuring a series of datasets to be implemented in training a language model (LM). Respective datasets can be automatically configured to comply with one or more configuration requirements of the LM, e.g., with regard to content, formatting, tabular form, correct license, etc. By implementing automated configuration, a plethora of datasets can be automatically configured to enable application of a multitude of datasets on a LM, enable a subsequent fused LM to be generated based fusion of the multitude of datasets.

### BACKGROUND

The subject disclosure relates to language models (LMs), and more specifically applying multiple fine-tuning operations to generate a fused LM.

### SUMMARY

The following presents a summary to provide a basic understanding of one or more embodiments described herein. This summary is not intended to identify key or critical elements, or delineate any scope of the different embodiments and/or any scope of the claims. The sole purpose of the Summary is to present some concepts in a simplified form as a prelude to the more detailed description presented herein.

In one or more embodiments described herein, systems, devices, computer-implemented methods, methods, apparatus and/or computer program products are presented that facilitate automatically configuring a series/collection of datasets for implementation in training/fine-tuning a language model (LM).

According to one or more embodiments, a system is provided to configure a plethora of datasets. The system can comprise a memory operatively coupled to the system, wherein the memory stores computer executable components and a processor that executes the computer executable components stored in the memory. The computer executable components can comprise a dataset configuration component configured to automatically convert a first original dataset to a first modified dataset, wherein the first modified dataset is created in accordance with at least one requirement of a language model (LM), wherein the first modified dataset is utilized to train the LM. In an embodiment, the dataset configuration component can be further configured to apply the first modified dataset to the LM to create a first modified LM. In another embodiment, the dataset configuration component can be further configured to identify a license associated with the first original dataset, determine a scope of the license, and in the event of the license does not permit use of the first original dataset to train the LM, reject implementation of the first original dataset with the first original dataset.

In a further embodiment, the dataset configuration component can be further configured to format the first original dataset in a tabular format to create the first modified dataset, identify a first column of data in the first modified dataset as comprising input data, wherein the input data is to be applied to the LM, and further identify a second column of data in the first modified dataset as comprising output data comparable to data output from the LM. In a further embodiment, the dataset configuration component can be further configured to identify a first collection of data in the first original dataset, wherein the first collection of data has a first language format, and convert the first collection of data to a second language format, wherein the second language format is a language required to train the LM.

In a further embodiment, the dataset configuration component can be further configured to identify a base data format, wherein the base data format has a structure required for application of data to train the LM, apply the base data format to the first original dataset, and further format the first original dataset to comply with the base data format.

In a further embodiment, the dataset configuration component can be further configured to identify a first column of data in the first original dataset, identify a second column of data in the first original dataset, and compare the content of the first column of data with the content of the second column of data to determine whether: the first column of data or the second column of data comprises input data, and/or the first column of data or the second column of data comprises output data.

In another embodiment, the dataset configuration component can be further configured to automatically convert a second original dataset to a second modified dataset, wherein the second modified dataset is created in accordance with at least one requirement of the LM, wherein the second modified dataset is utilized to train the LM, apply the second modified dataset to the LM to create a second modified LM, and fuse the first modified LM with the second modified LM to form a fused LM, wherein the fused LM comprises a combination of first features present in the first modified LM with second features present in the second modified LM.

In a further embodiment, the dataset configuration component can be further configured to generate a first modified dataset from the first original dataset, wherein the first modified dataset comprises first data from a first column of data in the first original dataset with second data from a second column of data in the first original dataset, and generate a second modified dataset from the first original dataset, wherein the second modified dataset comprises the first data from the first column of data in the first original dataset with third data from a third column of data in the first original dataset.

In another embodiment, the dataset configuration component can be further configured to analyze a first original dataset, determine whether at least a portion of the first original dataset is corrupted data, discard a first portion of the first original dataset comprising corrupted data, and retain a second portion of the first original dataset, wherein the second portion of the first original dataset comprises data for implementation in training the LM.

In other embodiments, elements described in connection with the disclosed systems can be embodied in different forms such as computer-implemented methods, computer program products, or other forms. In an embodiment, the computer-implemented method can comprise automatically converting a first original dataset to a first modified dataset, wherein the first modified dataset is created in accordance with at least one requirement of a language model (LM), wherein the first modified dataset is utilized to train the LM. In a further embodiment, the computer-implemented method can further comprise formatting the first original dataset with a tabular format to create the first modified dataset, identifying a first column of data in the first modified dataset as comprising input data, wherein the input data is to be applied to the LM, and identifying a second column of data in the first modified dataset as comprising output data comparable to data output from the LM.

In a further embodiment, the computer-implemented method can further comprise automatically converting a second original dataset to a second modified dataset, wherein the second modified dataset is created in accordance with at least one requirement of the LM, wherein the second modified dataset is utilized to train the LM, applying the second modified dataset to the LM to create a second modified LM, and fusing the first modified LM with the second modified LM to form a fused LM, wherein the fused LM comprises a combination of first features present in the first modified LM with second features present in the second modified LM.

In a further embodiment, the computer-implemented method can further comprise generating a first modified dataset from the first original dataset, wherein the first modified dataset comprises first data from a first column of data in the first original dataset with second data from a second column of data in the first original dataset, and generating a second modified dataset from the first original dataset, wherein the second modified dataset comprises the first data from the first column of data in the first original dataset with third data from a third column of data in the first original dataset.

Another embodiment can further comprise a computer program product stored on a non-transitory computer-readable medium and comprising machine-executable instructions, wherein, in response to being executed, the machine-executable instructions cause a machine to perform operations, comprising automatically converting a first original dataset to a first modified dataset, wherein the first modified dataset is created in accordance with at least one requirement of a language model (LM), wherein the first modified dataset is utilized to train the LM. In a further embodiment, the operations can further comprise applying the first modified dataset to the LM to train the LM and create a first modified LM. In a further embodiment, the operations can further comprise formatting the first original dataset with a tabular format to create the first modified dataset, identifying a first column of data in the first modified dataset as comprising input data, wherein the input data is to be applied to the LM, and identifying a second column of data in the first modified dataset as comprising output data comparable to data output from the LM.

In a further embodiment, the operations can further comprise automatically converting a second original dataset to a second modified dataset, wherein the second modified dataset is created in accordance with at least one requirement of the LM, wherein the second modified dataset is utilized to train the LM, applying the second modified dataset to the LM to create a second modified LM, and fusing the first modified LM with the second modified LM to form a fused LM, wherein the fused LM comprises a combination of first features present in the first modified LM with second features present in the second modified LM.

In another embodiment, the operations can further comprise generating a first modified dataset from the first original dataset, wherein the first modified dataset comprises first data from a first column of data in the first original dataset with second data from a second column of data in the first original dataset, and generating a second modified dataset from the first original dataset, wherein the second modified dataset comprises the first data from the first column of data in the first original dataset with third data from a third column of data in the first original dataset.

### DESCRIPTION OF THE DRAWINGS

One or more embodiments are described below in the Detailed Description section with reference to the following drawings:

FIG. 1 illustrates a system which can be utilized to configure respective datasets for application in fine-tuning a base language model, in accordance with one or more embodiments.

FIG. 2A presents a high-level system overview of datasets being modified for application in a fused language model, in accordance with one of more embodiments presented herein.

FIG. 2B illustrates a system configured to assess an output of a language model being compared with a predicted output from a dataset, in accordance with an embodiment.

FIG. 3 presents a computer-implemented methodology for automatically modifying/formatting datasets for implementation upon a language model, according to one or more embodiments.

FIG. 4 illustrates a computer-implemented methodology for automatically selecting and determining input and output data in a dataset for implementation upon a language model, according to one or more embodiments.

FIG. 5 illustrates a computer-implemented methodology for automatically selecting columns of data to merge to create an input value in a dataset for implementation upon a language model, according to one or more embodiments.

FIG. 6 illustrates a computer-implemented methodology for automatically merging data to create input values in a merged dataset for implementation upon a language model, according to one or more embodiments.

FIG. 7 presents a computer-implemented methodology to automatically determine whether a dataset can be utilized to train a language model, according to one or more embodiments.

FIG. 8 depicts an example schematic block diagram of a computing environment with which the disclosed subject matter can interact/be implemented at least in part, in accordance with various aspects and implementations of the subject disclosure.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

### TERMS

Input/Output: during training of a LM, first data in a dataset can be utilized as input data and second data in the dataset can be utilized as output data. Hence, during training of an LM, an input value (e.g., taken from the first data in the dataset) can be applied to the LM, while an output of the LM can be compared with the second data (e.g., identified as output data) to determine whether the LM is generating the desired output in response to the applied input. In an example scenario, as further described, the first data can comprise a string of text/a statement, and the second data can comprise a numeric value. Hence, the first data statement can be an LM input while the numeric value of the second data can be the anticipated output of the LM. In the event of, e.g., during training, the LM outputs a value comparable to the value of the respective second data numeric value associated with the first data statement, the LM can be considered to be performing as anticipated. Further, in the event of, during training, the LM outputs a value that is disparate to the value of the respective second data numeric value associated with the first data statement, the LM can be considered to be performing incorrectly, and further training is required. In an embodiment, as further described herein, data compiled to create input data or output data may be incorrectly formed.

Ranges A-n are utilized herein to indicate a respective plurality of devices, components, statements, attributes, etc., where n is any positive integer.

Language models (LMs), and their application, are becoming commonplace in today's society in the form of artificial intelligence (AI) chatbots, generative AI applications, natural language processing (NLP), and suchlike. LMs and large language models (LLMs) can be formed with a neural network that is highly complex, for example, comprising billions of weighted parameters. Training of LMs/LLMs (the terms are used interchangeably hercon in) can be conducted with datasets, whereby the datasets can be formed using any suitable technology, such as web crawlers configured to crawl and retrieve digital content (e.g., web-crawled data) from the World Wide Web/websites, online discussions, and suchlike. The datasets can be available from many sources, e.g., collected by an entity (e.g., customer data collected by a bank), a dataset selected from a hub, and suchlike. Further, the datasets can comprise text, alphanumerics, numbers, single words, phrases, short statements, long statements, images, audio, ctc. Fine-tuning of a LM can comprise application of a dataset to the LM, the LM is correspondingly adjusted by application of the dataset, such that, for example, weightings in the LM are adjusted by application of the dataset. In an aspect, by applying a multitude of datasets to a LM, and generating multiple fine-tuned/trained models from an original LM, a fused LM comprising the multiple fine-tuned models can be formed, wherein the fused LM can have more extensive application than a fused model that is trained on fewer datasets/a single dataset.

An approach to fine-tuning a LM is the individual application of multiple datasets to the LM to such that a collection of fine-tuned models are generated by the respective application of each dataset, e.g., a multitask operation, and as the number of applied datasets increases a massive multitask operation can ensue. Furthering the approach, the respective fine-tuned models in the collection of fine-tuned models can be fused together to form a fused model, such that, for example, the weightings present in the fused model are a function (e.g., an average) of the weightings present in each fine-tuned model in the collection of fine-tuned models.

As mentioned, the number and variety of datasets available to be applied to a base model, and further fine-tune the base model, is vast and growing daily. Accordingly, while it would be beneficial to manually apply as many datasets as possible to the base model to generate the respective fine-tuned models, the variety in the structure, content, etc., of the respective datasets renders it a largely impossible task to manually configure each of the respective datasets to be in a format suitable for fine-tuning the base model.

Accordingly, it would be beneficial to implement/configure a system that can automatically review a dataset for potential application for fine-tuning the base model, and further, configure the dataset to (a) comply with a data format/structure for implementation with the base model, (b) comprise content that pertains to the base model and finetuning of the base model, (c) satisfies usage issues (e.g., licensing), and suchlike. Further, the foregoing can be automatically conducted over numerous potential datasets available to fine-tune a LM.

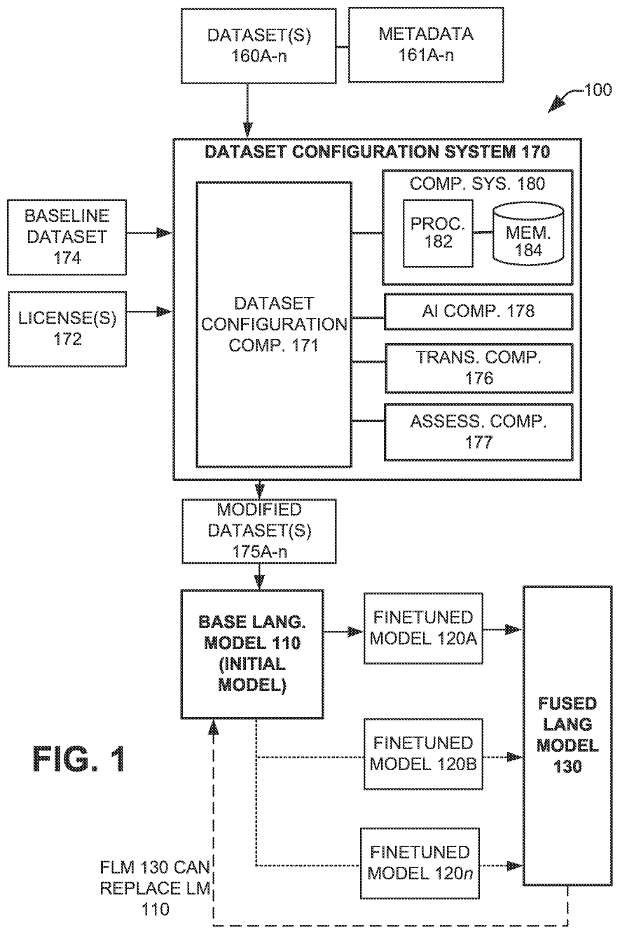

Turning now to the drawings, FIG. 1 illustrates a system 100 that can be utilized to configure respective datasets for application in fine-tuning a base model LM, in accordance with one or more embodiments. System 100 comprises a base model (e.g., an initial LM model) 110, which as further described, can undergo fine-tuning by application of respective datasets 160A-n/modified datasets 175A-n to form respective fine-tuned models 120A-n, wherein the fine-tuned models 120A-n can be further combined/fused together to form a fused LM 130. Accordingly, the base model 110 can undergo respective fine-tuning from which the fused LM 130 is formed. During a fine-tuning operation, a dataset (e.g., any of datasets 160A-n) can be applied to the base model 110, such that a first entity/contributor may apply a first dataset 160A to the base model 110 to create a fine-tuned model 120A, a second entity may apply a second dataset 160B to the base model 110 to create a fine-tuned model 120B, an nth entity may apply an n^{th} dataset 160n to the base model 110 to create a fine-tuned model 120n, and suchlike. The fine-tuned models 120A-n can be fused to form the fused language model (LM) 130.

As mentioned, the various datasets 160A-n may be sourced/compiled from a variety of sources, etc., and hence may exist in a variety of forms, formats, variety of data content, and suchlike. The various datasets 160A-n can be proprietary and/or open sourced, filtered/unfiltered, edited/unedited, and suchlike. Accordingly, attempting to manually review/edit the respective datasets 160A-n can be a Herculean task and time-consuming to the point that the application of the datasets 160A-n becomes prohibitively untimely. Accordingly, implementing an automated process to review/configure/apply the datasets is beneficial.

As illustrated, system 100 can further include a dataset configuration system (DCS) 170, which can further comprise a dataset configuration component (DCC) 171 which can be configured to analyze/review a dataset 160A-n to determine whether the dataset 160A-n contains data/information that pertains to fine-tuning the base model 110, and further, can configure/format a dataset 160A-n such that the dataset 160A-n can be implemented to fine-tune the base model 110.

As further described, the following operations in a simplified pipeline of operations can be performed by the DCC 171:

1) identify any of datasets 160A-n that are suitable/unsuitable for implementation in fine-tuning the base model 110. For example, an unsuitable scenario may comprise dataset 160A-n is corrupt, dataset 160A-n is not licensed for use, and suchlike.

2) format dataset 160A-n to a format suitable for implementation with the base model 110. For example, the dataset 160A-n can be filtered/re-compiled into a common format.

3) automatically determine the type of information/content of a respective portion of a dataset 160A-n and/or the entire dataset 160A-n. For example, in the event of the dataset 160A-n is in a tabular form, content of each respective column of data in the table can be determined.

4) automatically determine input data and output data present in the dataset 160A-n to fine-tune the base model 110.

5) create/generate multiple training regimes (e.g., fine-tuned models 120A-n) generated from application of each dataset 160A-n against the base model 110.

6) generate a fused language model 130 by fusing together the fine-tuned models 120A-n.

Expanding on 1-6 above,

(1) licenses: in an embodiment, the DCC 171 can be configured to review/analyze a dataset 160A to (a) identify a license (e.g., license(s) information 172) associated with the dataset 160A, and (b) in the event of the license does not apply to the base model 110/fine-tuning operation, the DCC 171 can indicate (e.g., flag) that the dataset 160A does not pertain to the base model 110 and/or the fine-tuning operation. For example, the license may be for non-commercial use only, while the base model 110 is directed towards commercial use. In an embodiment, can review metadata 161A-n associated with the dataset 160A-n to assist in determination of whether the dataset 160A-n is suitable for implementation. License information 172 can indicate that the respective dataset 160A-n is legally permitted for one or more of individual use, personal use, commercial use, research use, and suchlike). In another aspect, the DCC 171 can be configured to determine the integrity of a dataset 160A-n, such that it might not be possible to open the dataset 160A-n or a portion of the dataset 160A-n may be corrupted and cannot be utilized. In an embodiment, the corrupted portion can be discarded/ignored and the uncorrupted portion retained for implementation in training the LM 110.

(2) suitability of a dataset 160A-n can be determined, e.g., a dataset 160F may be in a format such that the dataset 160F cannot be immediately applied to the LM 110, with dataset 160F requiring to be configured in a format for implementation with the LM 110. For example, DCC 171 can be configured to automatically review/parse the format and/or content to determine whether dataset 160F is in a (a) byte-form, (b) has a complex structure, (c) the data comprises unique identifiers that are of no use beyond the entity that created the data, and suchlike, such that DCC 171 is unable to automatically manipulate a raw/original format of dataset 160F into a format applicable to base model 110. Furthering the example, a row of data in dataset 160F may contain a graph structure with information that cannot be automatically fitted into a text-to-text training/fine-tuning application, whereby, DCC 171 can be configured to automatically remove/extract/delete the information in the row of data in dataset 160F. In the further event of removing the row of data in the dataset 160F causes the dataset 160F to be emptied, the DCC 171 can be further configured to flag the dataset 160F as unsuitable for implementation with the base model 110. Upon completion of the formatting operation, any remaining datasets 160A-n can be determined by DCC 171 to have a valid format for fine-tuning the base model 110. For example, the formatted dataset 160A-n may comprise tabular form in conjunction with any associated metadata 161A-n. In an embodiment, the DCC 171 can be configured to utilize a baseline dataset 174 to assist the DCC 171 in determining whether a dataset, e.g., dataset 160A, pertains to fine-tuning the base model 110. The baseline dataset 174 (e.g., base data) may have been previously applied to the LM 110 and worked/performed well (e.g., outputs from the LM 110 matched predicted outputs in the baseline dataset 174), accordingly, the DCC 171 can utilize the baseline dataset 174 as a template against which prospective datasets 160A-n can be assessed. As part of the configuration of dataset 160A-n, the DCC 171 can convert the respective dataset 160A-n into a tabular form (e.g., to a comma-separated values file (.csv), and suchlike), wherein the respective columns (or rows) of data have associated content.

(3) data processing: the DCC 171 can be configured to ensure that content of the respective dataset 160A-n is relevant/pertains to training/fine-tuning base model 110. For example, content in dataset 160A-n may exist in a first language (e.g., Finnish), while the base model 110 requires the content in dataset 160A-n to be in a second language (e.g., English). Accordingly, the DCC 171 can be configured to utilize a translation component (e.g., translation component 176) to translate the content in dataset 160A-n from the first language to the second language. In another embodiment, the content in dataset 160A-n may be in a first number format (e.g., hexadecimal, binary, numeral system (e.g., Chinese, Hebrew, Korean, etc.), and suchlike), while the base model 110 is to be trained with a first number format (e.g., Western Arabic, decimal). Accordingly, the DCC 171 can be configured to translate (e.g., via translation component 176) the content in dataset 160A-n from the first numeric form to the second numeric form.

Further, the DCC 171 can be configured to utilize any information available regarding the content, structure, format, etc., of the dataset 160A-n. For example, in an embodiment, the DCC 171 can be configured to review any metadata 161A-n associated with the dataset 160A-n to determine content of the dataset 160A-n, a column title/heading, and suchlike.

(4) input/output determination: the DCC 171 can be configured to determine for each dataset 160A-n, which columns in dataset 160A-n are respective candidates that contain relevant information regarding input information and/or output information. For example, DCC 171 can be configured to remove/ignore columns with an identification (ID) in their name, remove columns having one or more words that does not appear in a known dictionary, remove column(s) that includes one or more words that are known to not be of interest, remove graph knowledge when training of the base model 110 is to be based on images or text (and vice-versa), etc. In a further embodiment, the DCC 171 can be configured to combine two or more columns as required to create a respective input and/or output, e.g., two columns of textual data are merged to create respective inputs. In a further embodiment, more columns of potentially pertinent data may be present than simply a first column (input text) and a second column (output text), e.g., three columns of textual data are present in dataset 160G. Accordingly, DCC 171 can be configured to determine which data is pertinent to a given training task, such that in the event of, for example, three columns of textual data are present in dataset 160G, DCC 171 can be configured to automatically determine that a first column in dataset 160G comprises text pertaining to input data and a third column in dataset 160G comprises text pertaining to output data, and the second column of data does not pertain to the particular training task to be applied to base model 110. In an example scenario of application, as further described, input data in a dataset 160A-n can comprise an image(s) such that the LM is configured to receive an input comprising an image, and further generate an output that can also be an image, text, etc., wherein the output can be compared with an anticipated output identified in dataset 160A-n.

In an embodiment, DCC 171 can be configured to operate in conjunction with an AI component 178, such that the AI component 178 can infer potential data entries, column types/data, etc., e.g., to create respective input data/output data.

(5) Training: for each dataset 160A-n the DCC 171 can be configured to automatically deduce (e.g., in conjunction with AI comp. 178) the most relevant way to implement the respective dataset 160A-n for training a respective base model 110. For example, if a dataset 160B includes two columns, a first column that includes first data having long texts and a second column that includes data having short text, DCC 171 can be configured to automatically determine that the first data, long texts, is more suitable/likely to be an input for training that the short text data included in the second column. In another example, in the event of a first column of data in dataset 160C comprises images and a second column of data in dataset 160C comprises text, both the first column and the second column may be relevant/applicable for training, and the actual implementation (e.g., data in first column versus data in second column) depends on the particular training to be performed. In a further example, in a scenario that a dataset 160G comprises a first column comprising data having a textual string format and a second column comprising data having a numeric format, the DCC 171 can make an initial inference that the textual string data in the first column can likely be utilized as input values in training the base model 110 and the numeric data in the second column can likely be utilized as output values when training the base model 110.

In another embodiment, a dataset 160H can comprise of a series of columns, e.g., ten columns of data. The DCC 171 can review the respective columns of data and determine that the respective data comprises short statements/single words. The DCC 171 can be configured to combine data in a first column with data in an n^{th} column to create respective input data to be utilized in training base model 110, and further, the DCC 171 can be configured to identify data in another column that can be utilized as output data when training the base model 110.

In another embodiment, in the event of a dataset 160A-n comprises a variety of columns of data, wherein the respective columns of data pertain to each other, the DCC 171 can be configured to generate a variety of modified datasets 175A-n from a single dataset 160A-n. For example, a dataset 160K comprises 5 columns of data that all pertain to respective entities (e.g., customers of a bank and their accounts) and a column of data that can be deduced/predicted from information in the first 5 columns of data. Accordingly, from dataset 160K, the DCC 171 can be configured to generate a first modified dataset 175K-1 comprising input data created from column 1 and output data from column 6, a second modified dataset 175K-2 comprising input data created from column 2 and output data from column 6, a third modified dataset 175K-3 comprising input data created from a combination of data in columns 2 and 3, and output data from column 6, and suchlike. Hence, the DCC 171 can be configured to generate more than one modified dataset 175A-n from a single dataset (e.g., dataset 160K).

It is to be appreciated that the foregoing are simply example scenarios and the various embodiments are applicable to any scenario where respective data can be identified/isolated and further combined, as required.

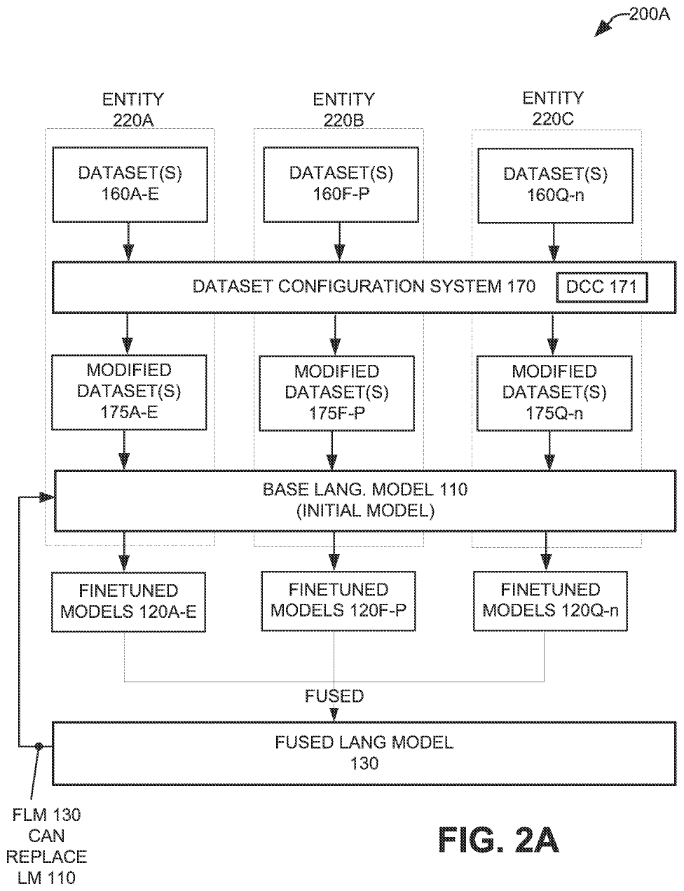

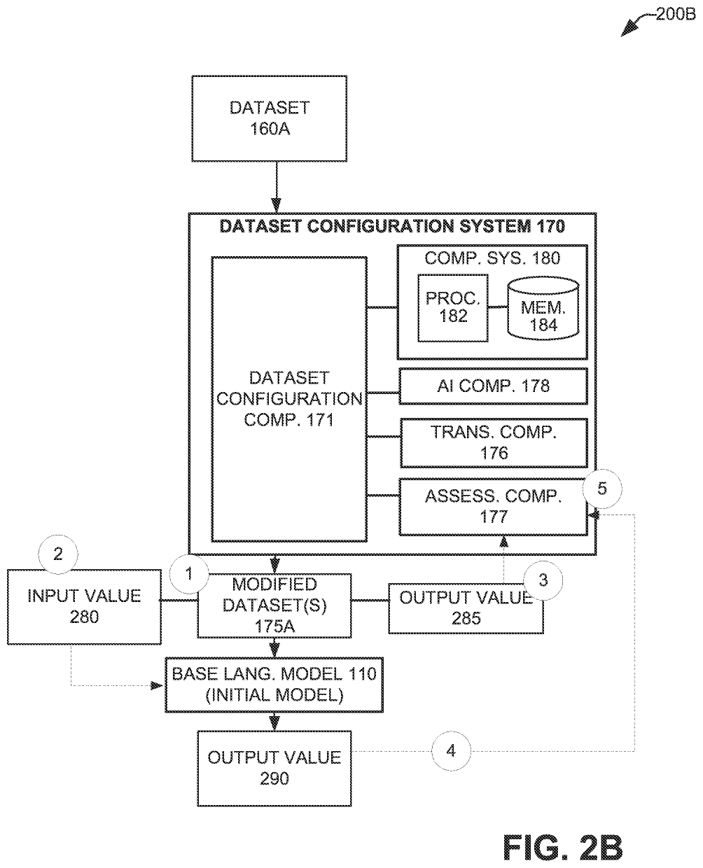

As illustrated in FIG. 1, the DCC 171 can be further configured to operate in conjunction with an assessment component 177, wherein functionality of the assessment component 177 is further described in FIG. 2B.

As shown in FIG. 1, per the foregoing, the respective dataset 160A-n is modified by the DCC 171, with a modified dataset 175A-n respectively generated by the DCC 171. As previously mentioned, while the dataset 160A-n in its original/initial form may not be in the format, structure, etc., as required to train the base model 110 (e.g., as part of a finetuning process, as previously described), the modified dataset 175A-n generated by the DCC 171 from the respective initial dataset 160A-n can be in the required format/content.

As further shown in FIG. 1, as a function of implementing each modified dataset 175A-n upon the base model 110, (e.g., as part of a fine-tuning/training process), a trained/fine-tuned model 120A-n is generated. As previously mentioned, and as further presented in FIG. 1. the respective fine-tuned models 120A-n can be fused together to generate a fused LM 130. Hence, the fused LM 130 can be generated as a function of the respective features of the individual fine-tuned models 120A-n, for example, the parameter weightings of the fused LM 130 are a function of the respective parameter weightings of the respective fine-tuned models 120A-n. As further shown, the fused LM 130 can subsequently be implemented as the initial model (e.g., replaces the base model 110) with current modified datasets 175A-n and any future modified datasets applied to the fused LM 130 (e.g., acting as the initial model).

As mentioned, the DCS 170 can include an AI component 178. Per the various embodiments presented herein, the DCC 171 can be configured to utilize the AI comp. 178 to perform various operations and inferences. For example, as described herein, AI comp. 178 can be utilized to infer one or more data values in a dataset 160A-n and/or modified datasets 175A-n, based upon other data values present in a dataset. As described herein, when two datasets (e.g., dataset 160A and dataset 160B) having a tabular format are merged, empty cells may result as part of the merging process. DCC 171, in conjunction with AI comp. 178, can review respective data present in the merged table (e.g., merged dataset 160C) and infer values to populate the empty cells. In another embodiment, DCC 171, in conjunction with AI comp. 178, can be configured to identify data (e.g., in a first column in a first dataset 160A) that can be utilized as input data and further identify data (e.g., in a second column in a second dataset 160F) that can be utilized as output data (e.g., against which operation of the LM 110 can be determined).

As shown in FIG. 1, DCS 170 can further include a computer system 180. Computer system 180 can include a memory 184 that stores the respective computer executable components (e.g., DCC 171, translation comp 176, assessment comp 177, AI comp 178) and further, a processor 182 configured to execute the computer executable components stored in the memory 184. Memory 184 can further be configured to store any of datasets 160A-n, baseline dataset 174, licenses 172, modified datasets 175A-n, base LM 110, fine-tuned models 120A-n, fused LM 130, and suchlike.

FIG. 2A, system 200A, presents a high-level overview of the datasets being modified for application in a fused language model, in accordance with one of more embodiments presented herein. As shown, a first entity 220A can utilize various datasets 160A-E, a second entity 220B can utilize datasets 160F-P, and a third entity 220C can utilize datasets 160Q-n. Each entity 220A-n can apply their respective datasets 160A-n to the DCC 171. It is to be appreciated that while FIG. 2A depicts the DCC 171 being a common component being utilized by the respective entities 220A-n, the DCC 171 can be a distributed application/component, with respective instances of the DCC 171 operating local to each of the entities 220A-n (e.g., entity 220A is a research institution, entity 220B is a government entity, entity 220n is a commercial enterprise, and suchlike), wherein the DCC 171 can be updated as required to ensure that the respective entities were utilizing a current version of DCC 171.

As described per the various embodiments presented herein, the DCC 171 can be configured to configure the respective datasets 160A-n for implementation with the base model 110. Accordingly, as described herein, configuration of the respective datasets 160A-n transforms the datasets 160A-n from their respective initial format to a modified format, creating modified datasets 175A-n, as shown. The modified datasets 175A-n can be applied to the base model 110 as part of a training/fine-tuning operation. For each respective application of a modified dataset 175A-n a fine-tuned model 120A-n is generated. As per the various embodiments presented herein, the fine-tuned models 120A-n can be fused together to form the fused LM 130. Hence, application of the DCC 171 to automatically configure the respective datasets 160A-n to create the modified datasets 175A-n, enables a plethora of disparate datasets 160A-n to be utilized to create the fused LM 130.

FIG. 2B, system 200B, illustrates assessment of an output of a language model being compared with a predicted output from a dataset, in accordance with an embodiment. As previously mentioned, the DCC 171 can operate in conjunction with an assessment component 177, wherein the assessment component 177 can be configured to determine (a) operation of a model (e.g., LM 110) and/or (b) implementation of a modified dataset (e.g., 175A-n). As shown in FIG. 2B, at (1) the DCC 171 can review/configure a dataset 160A and as part of creating a modified dataset 175A from dataset 160A, the DCC 171 can identify/determine an input value/data 280 and an output value/data 285, as previously described.

At (2) of FIG. 2B, the input value 280 identified in the modified dataset 175A can be applied to the LM 110.

At (3) of FIG. 2B, the output value 285 generated by the DCC 171 can be applied to the assessment component 177.

At (4) of FIG. 2B, as previously described, the LM 110 can be configured to receive the input value 280 and generate an output value 285 based on the input value 280 (e.g., as part of a fine-tuning/training operation). The output value 290 can be applied to assessment component 177.

At (5) of FIG. 2B, upon receipt of the output value 285 and the output value 290, the assessment component 177 can be configured to determine a degree of similarity between the output value 285 and the output value 290. In the event of the assessment component 177 determines that the output value 285 and the output value 290 are similar (e.g., have a high degree of similarity) the assessment component 177 can be configured to indicate to the DCC 171 that (a) the output value 285 was correctly identified by the DCC 171 in the dataset 160A as application of the input value 280 to the LM 110 produced an output value 290 having a predicted value, and/or (b) the model 110 is functioning as anticipated. In the event of the assessment component 177 determines that the output value 285 and the output value 290 are dissimilar (e.g., have a low degree of similarity) the assessment component 177 can be configured to indicate to the DCC 171 that (a) the output value 290 was incorrectly identified by the DCC 171 in the dataset 160A as application of the input value 280 to the LM 110 produced an output value 290 having an unpredicted value, and/or (b) the model 110 is not functioning as anticipated. Accordingly, operation of DCC 171 can be reviewed to determine if the DCC 171 is incorrectly identifying input/output data, and/or operation of the LM 110 can be reviewed to determine whether the LM 110 requires further training/fine-tuning.

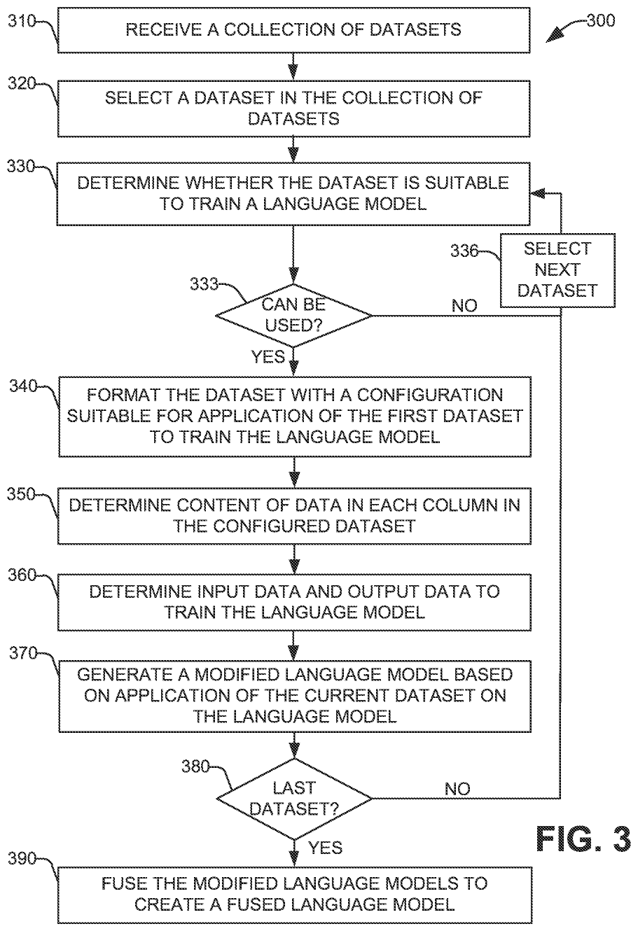

FIG. 3, methodology 300, illustrates a computer-implemented methodology for automatically modifying/formatting datasets for implementation upon a language model, according to one or more embodiments.

At 310, one or more datasets can be received, wherein the one or more datasets (e.g., datasets 160A-n) have the potential to be utilized to train a LM (e.g., base LM 110). As previously mentioned, the one or more datasets can be obtained from a variety of sources, e.g., proprietary data collected by an entity, selected from a hub of datasets,

At 320, a dataset (e.g., dataset 160A, a first dataset) can be selected from the one or more datasets.

At 330, the dataset can be reviewed by a dataset configuration component (e.g., by DCC 171) to determine whether the dataset is suitable to train the LM. As previously described, the DCC can be configured to analyze content of the LM to assess such issues as (a) does the dataset have sufficient integrity such that there is data of use in the dataset or is the dataset overly corrupted?, (b) does the licensing/legal requirements of the dataset enable the dataset to be used to train the LM?, (c) can the dataset be converted to a format amenable for implementation with the LM?, and suchlike.

At 333, in response to any of the concerns raised at 330, that NO, the dataset is determined by the DCC to not be amenable for use to train the LM, the dataset can be set aside/rejected and another dataset (e.g., dataset 160B, a second dataset) can be selected for review by the DCC for implementation to train the LM. In an embodiment, the DCC can be configured to flag/apply rejection metadata to the rejected dataset indicating why the dataset was determined to not be suitable to train the LM. Accordingly, in the event of the dataset subsequently being a candidate for implementation to train the LM, the DCC can review the rejection metadata to determine why the dataset was not previously implemented. Methodology 300 can advance to 336, whereupon the next dataset can be selected, for further determination of whether the next dataset is suitable for implementation.

At 333, in the event of the DCC determines that YES, the dataset can be implemented to train the LM, methodology 300 can advance to 340.

At 340, the DCC can configure the dataset with a format suitable for implementation in training the LM. As previously mentioned, a suitable format can be a tabular/table format, wherein the respective columns comprise related data (e.g., to enable input and output values to be determined/obtained, e.g., by the DCC).

At 350, the DCC can review the content of each column to determine the respective content, e.g., text string, number, etc.

At 360, based in part on the determined content of each column, the DCC can further determine whether data in a first column is to be utilized as input data or output data, whether data in a second column is to be utilized as input data or output data, and suchlike. In an example embodiment, a candidate dataset for training an LM can, at a minimum, comprise two columns of data, a first column of data is utilized as data to be input into the LM while the corresponding values in the second column of data can be utilized as output values to check/confirm that the LM has correctly generated an output that corresponds to the input value.

At 370, the respective identified inputs are applied to the LM, the outputs assessed, and accordingly, a modified LM is generated as a function of the dataset being applied to the LM, as previously described.

At 380, the DCC can determine whether the dataset currently being processed is the last dataset to be processed. At 380, in the event of the dataset currently being processed is not the last dataset to be processed, methodology 300 can return to 336 for the next dataset (e.g., a second dataset) can be selected from the one or more datasets, whereby the next dataset can be subsequently assessed at 330 for use in training the LM, and if acceptable, is utilized to train the LM, e.g., the implementation of the next dataset on the LM causes a second modified LM to be generated.

At 380, in the event of the current dataset being processed is the last dataset, methodology 300 can advance to 390, whereupon the respective modified language models (e.g., fine-tuned models 120A-n) respectively generated at 370 can be fused to create the fused language model (e.g., fused LM 130).

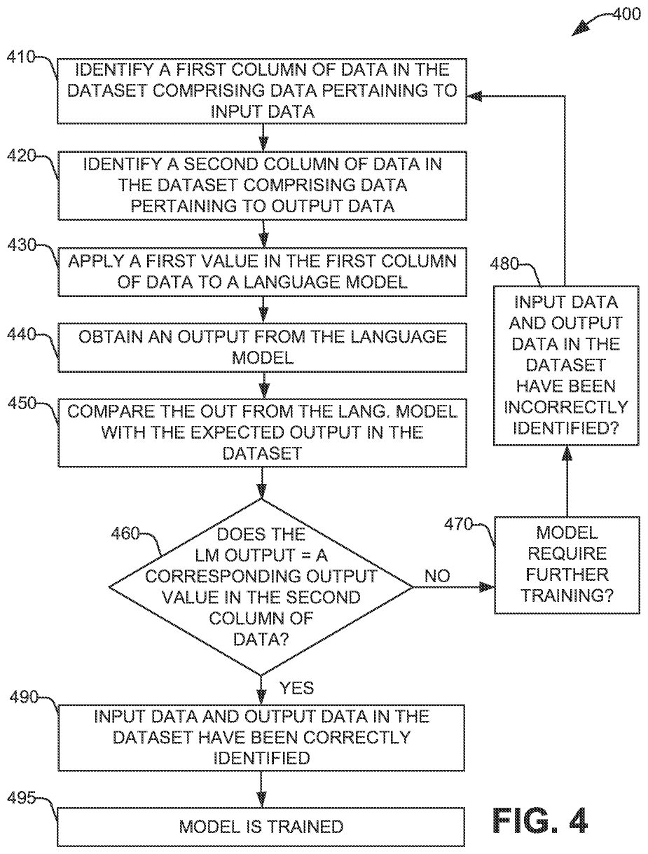

FIG. 4, methodology 400, illustrates a computer-implemented methodology for automatically selecting and determining input and output data in a dataset for implementation upon a language model, according to one or more embodiments.

At 410, a first column of data in a dataset (e.g., dataset 160A) can be automatically identified by a dataset configuration component (e.g., DCC 171) as input data (e.g., output data 280). As previously mentioned, at least one column in a dataset can be identified as containing terms, text strings, images, audio, etc., that pertain to being an input term/phrase/question/prompt.

At 420, a second column of data in the dataset can be automatically identified by the DCC as anticipated output data (e.g., as output data 285). As previously mentioned, a column in the dataset can be identified as containing a term, number, image, etc., that pertain to being an output term/phrase/image, and suchlike.

At 430, the DCC can apply a first value in the first column of data to a language model (LM 110), e.g., the first value functions as input data as part of a training/finetuning operation.

At 440, an output value (e.g., output value 290) can be generated/obtained (e.g., by the DCC) from the language model.

At 450, the DCC (e.g., by the DCC/assessment component 177) can compare the output value received from the language model with the anticipated output value in the second column of data that corresponds to/generated in response to the input value in the first column of data that was applied to the language model.

At 460, in the event of a determination (e.g., by the DCC/assessment component 177) that NO, the output value received from the language model is not comparable to the anticipated output in the second column of data in the dataset, methodology 400 can advance to 470, whereupon the DCC can make a determination (e.g., via assessment component 177) as to whether the language model requires further training/finetuning. Methodology 400 can further advance to 480, where a review (e.g., via assessment component 177) can be conducted as to whether the input data (e.g., identified as the first column of data) and/or the output data (e.g., identified as the second column of data) were correctly identified by the DCC. In the event that the DCC incorrectly determined the first column of data comprises input data and/or the second column of data comprises the output data, operation of the DCC can be further reviewed with a view to improving operation of the DCC with regard to correctly identifying input and/or output data. Accordingly, with the respective reviews of the operation of the DCC and associated improvement of operation, methodology 400 can return to 410 to repeat the automated process for identifying the input data and output data.

At 460, in response to a determination (e.g., by DCC/assessment component 177) that YES, the output value obtained from the LM is the same as the anticipated output value in the dataset, methodology 400 can advance to 490, whereupon a determination can be made that the DCC correctly identified the input data (e.g., in the first column of data) and the output data (e.g., in the second column of data) in the dataset. Further, at 495, in the event of the output value of the LM is the same as the anticipated output value in the dataset, the LM can be considered to be trained/fine-tuned (e.g., to form a fine-tuned model 120A).

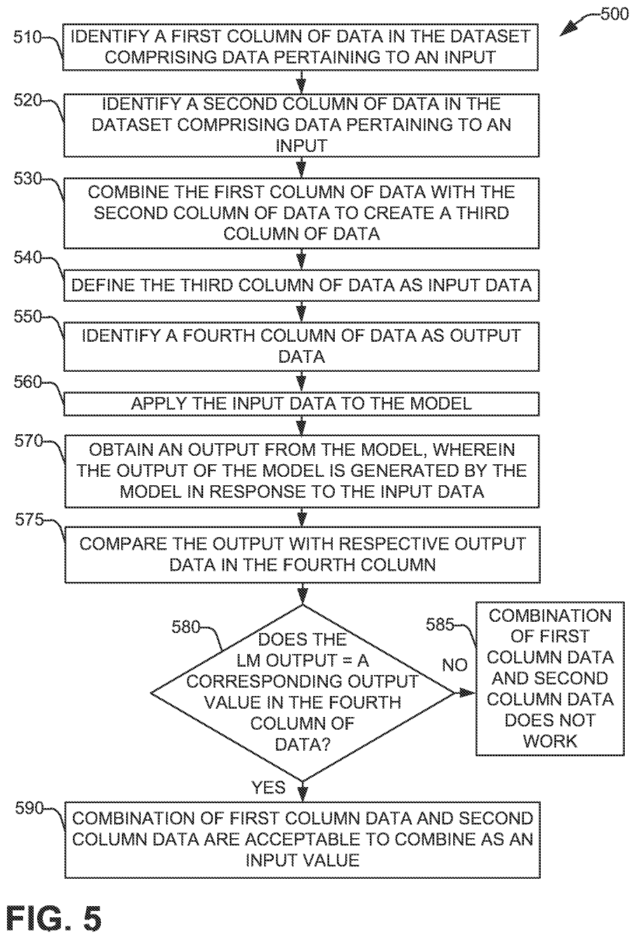

FIG. 5, methodology 500, illustrates a computer-implemented methodology for automatically selecting columns of data to merge to create an input value in a dataset for implementation upon a language model, according to one or more embodiments.

At 510, a first column of data in a dataset (e.g., dataset 160A) can be identified by a dataset configuration component (e.g., DCC 171) as comprising data having a format that may potentially combine with other data to form input data that can be applied to a base language model (e.g., base LM 110).

At 520, a second column of data in the dataset (e.g., dataset 160A) can be identified by the DCC as comprising data having a format that may potentially combine with other data (e.g., data in the first column) to form input data that can be applied to the base language model.

At 530, the data in the first column of data can be combined, e.g., by the DCC, with the data in the second column of data to form a third column of data. E.g., data 1 in column 1, row 1 is combined with data 2 in column 2, row 1 to form data 3 in column 3, row 1.

At 540, the data in the third column can be defined, e.g., by the DCC as input data.

At 550, data in a fourth column can be identified, e.g., by the DCC, as output data, with the expectation that the output data will be generated by the respective input data in the third column.

At 560, the newly derived input data can be applied, e.g., by the DCC, to a language model (e.g., base LM 110).

At 570, an output value can be obtained from the LM, e.g., by the DCC, wherein the output value is generated by the LM in response to the input data applied to the LM.

At 575, the output value obtained from the LM can be compared with the corresponding output value present in the fourth column. A determination can be made, e.g., by the DCC, regarding whether the output value obtained from the model is comparable/equivalent to the output value obtained from the fourth data column.

At 580, in the event of a determination (e.g., by the DCC/assessment component 177) that NO, the output value received from the language model is not comparable to the anticipated output in the fourth column of data, methodology 500 can advance to 585, wherein a determination can be made (e.g., by the DCC/assessment component) that the proposed combination of data in the first column with the second column does not produce an input data associated with an expected output data (e.g., in the fourth column). Accordingly, the combination of the first column of data with the second column of data can be rejected/discarded.

At 580, in the event of a determination (e.g., by the DCC/assessment component 177) that YES, the output value received from the language model is comparable to the anticipated output in the fourth column of data, methodology 500 can advance to 590, wherein a determination can be made (e.g., by the DCC/assessment component) that the proposed combination of data in the first column with the second column does combine to produce input data associated with an expected output data (e.g., in the fourth column). Accordingly, the combination of the first column of data with the second column of data can be maintained, and further applied to train/fine-tune the LM.

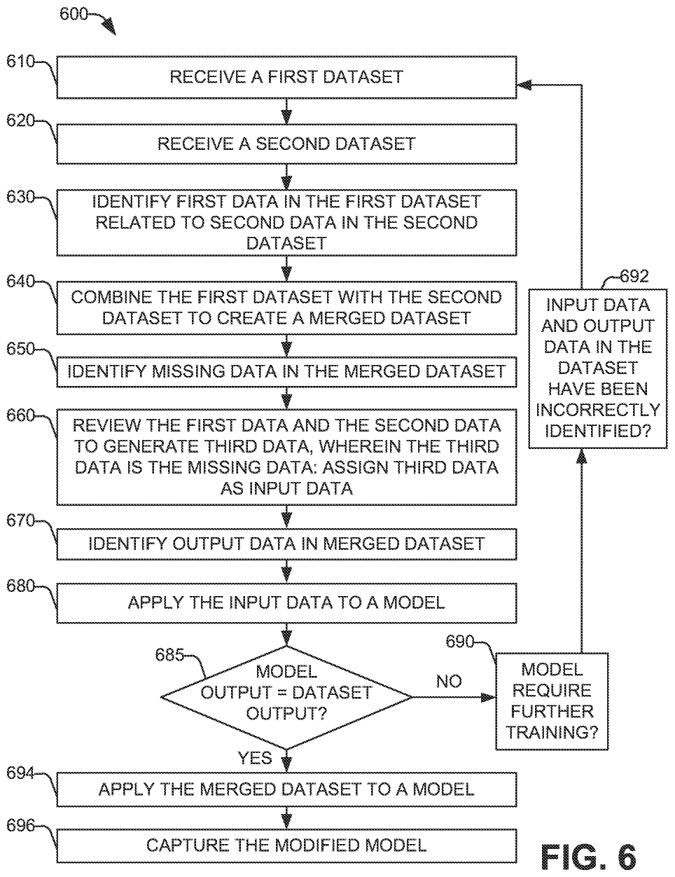

FIG. 6, methodology 600, illustrates a computer-implemented methodology for automatically merging data to create input values in a merged dataset for implementation upon a language model, according to one or more embodiments.

At 610, a first dataset (e.g., dataset 160A) can be received/obtained by a dataset configuration component (e.g., DCC 171).

At 620, a second dataset (e.g., dataset 160B) can be received/obtained by the DCC.

At 630, the DCC can be configured to review to the first dataset and second dataset to identify whether the respective datasets have related data. In an embodiment, the DCC can be configured to determine that while the first dataset and the second dataset are not identical/the same dataset, first data in the first dataset (e.g., in a first column of the first dataset) is related to second data in the second dataset (e.g., in a second column of the second dataset).

At 640, a third/merged dataset can be generated from the first dataset and the second dataset, thereby further extending the number of datasets available with which to train/fine-tune a language model (e.g., base LM 110). In an example scenario, the first dataset and the second dataset may both be incomplete, having gaps in the data they respective contain.

At 650, after the first dataset and the second dataset have been merged, gaps may be present, e.g., a first cell in the first dataset maps to a second cell in the second dataset, while a third cell in the first dataset does not map to a fourth cell in the second dataset, hence the merging of the first dataset with the second dataset may produce data gaps in the merged dataset. In an embodiment, the DCC can be configured to identify gaps in the data present in the merged dataset.

At 660, the DCC can be configured to review data in any of the first dataset, the second dataset, and/or the third dataset, to identify/infer suitable entries with which to fill the missing gaps. For example, the DCC can be configured to identify, for an incomplete set of data, a complete set of data associated with the incomplete set of data, and based on the complete set of data, infer a data value that fills the incomplete set of data. The DCC can be further configured to assign third data in the merged data generated from the first dataset and the second dataset as input data for implementation in training a model.

At 670, the DCC can be further configured to assign fourth data in the merged data generated from the first dataset and the second dataset as output data for review of data output during training a model.

At 680, the DCC can be configured to apply the identified input data to the language model (e.g., LM 110).

At 685, the DCC (e.g., in conjunction with assessment component 177) can be configured to determine whether the output data generated by the LM matches the output data identified in the merged data. In the event of NO, the LM output data does not match the output data in the merged data, methodology 600 can advance to 690, wherein the LM output data and the output data in the merged data can be compared to determine whether the LM requires further training, e.g., the output data in the merged data is considered to be correct/robust, but the LM output data does not match/is not similar to the output data in the merged data. Further, methodology 600 can advance to 692, whereupon, in the event of the of the data has been merged incorrectly (e.g., the LM output is reasonable but the output data in the merged data is not) the merging operation by the DCC can be reviewed/improved.

At 685, in the event of a determination (e.g., by the DCC/assessment component 177) of YES, the model output data matches/similar to the output data identified in the merged dataset, methodology 600 can advance to 694, whereupon the merged dataset can be applied in its entirety to the LM. Further, at 696, the LM (e.g., fine-tuned model 120A), as modified by the merged dataset, can be saved for further application part of generation of a fused LM (e.g., fused LM 130).

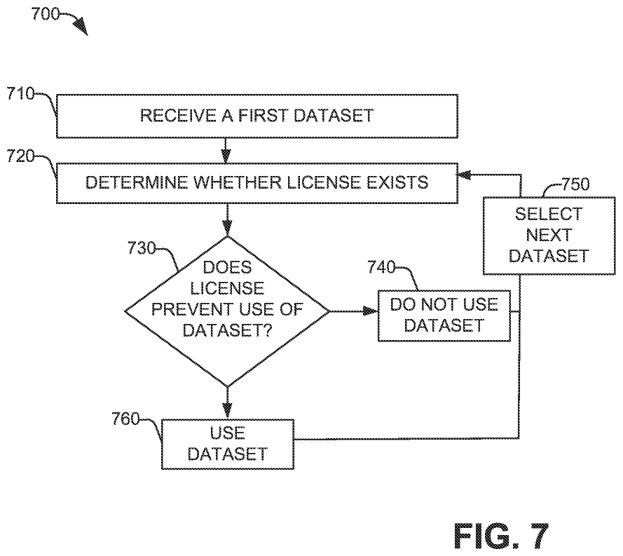

FIG. 7, methodology 700, illustrates a computer-implemented methodology to determine (e.g., automatically) whether a dataset can be utilized to train a language model, according to one or more embodiments.

At 710, a first dataset (e.g., dataset 160A) can be received at a dataset configuration component (e.g., DCC 171).

At 720, the DCC can review the dataset and any associated metadata (e.g., metadata 161A-n) to determine whether a license (e.g., license 172) limiting use of the dataset exists.

At 730, the DCC can make a determination regarding limitation(s) of the license, and whether the license prevents use of the dataset (e.g., license is for research, single use, commercial use, proprietary use, and suchlike). In the event of a determination that NO, the dataset cannot be used as a function of the license, methodology 700 can advance to 740, wherein the DCC can prevent usage of the dataset (e.g., flags as not to be used), whereupon the methodology 700 can further advance to 750 for the next dataset to be selected and reviewed by the DCC.

At 730, in the event of the DCC makes a determination that YES, the license enables use of the dataset, methodology 700 can advance to 760, whereupon the dataset can be further configured and implemented to train/fine-tune a language model (e.g., LM 110). The methodology can return to 750 for the next dataset to be selected for review by the DCC.

As used herein, the terms “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Per the various embodiments presented herein, various components included in the DCS 170, e.g., DCC 171, translation component 176, assessment component 177, AI component 178, and suchlike, can include AI and machine learning (ML) and reasoning techniques and technologies that employ probabilistic and/or statistical-based analysis to prognose or infer an action that a user desires to be automatically performed. The various embodiments presented herein can utilize various machine learning-based schemes for carrying out various aspects thereof. For example, a process (e.g., by DCC 171) for determining whether a dataset 160A-n can be utilized, and further, configuring the dataset 160A-n for implementation on a LM 110, and suchlike, as previously mentioned herein, can be facilitated via an automatic classifier system and process.

A classifier is a function that maps an input attribute vector, x=(x1, x2, x3, x4, xn), to a class label class (x). The classifier can also output a confidence that the input belongs to a class, that is, f(x)=confidence (class (x)). Such classification can employ a probabilistic and/or statistical-based analysis (e.g., factoring into the analysis utilities and costs) to prognose or infer an action that a user desires to be automatically performed (e.g., avoidance of an accident, and operations related thereto).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria, probability of an accident in conjunction with avoidance of an accident, for example.

As described supra, inferences can be made, and operations performed, based on numerous pieces of information. For example, whether input data 280 and output data 285 have been correctly identified by the DCC 171, the DCC 171 has correctly merged/identified data in the respective datasets 160A-n, whether the LM 110 is correctly trained/fine-tuned or requires further training, etc., translation component 176 correctly translated the dataset 160A-n, whether the DCC 171 has correctly configured the dataset 160A-n in view of the baseline dataset 174, and suchlike, enabling a plethora of datasets 160A-n to be automatically configured for implementation in training/fine-tuning a LM 110, and further creating a fused LM 130.

### EXAMPLE APPLICATIONS AND USE

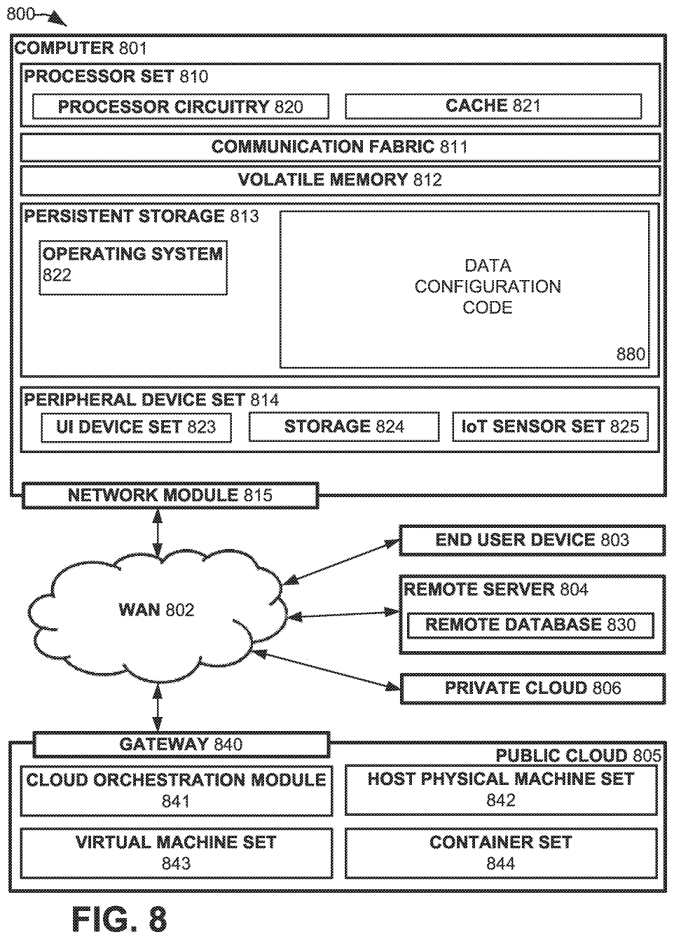

FIG. 8 and the following discussion are intended to provide a brief, general description of a suitable computing environment 800 in which one or more embodiments described herein at FIGS. 1-7 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as configuring a series/collection of datasets (e.g., datasets 160A-n) by a configuration component (e.g., DCC 171) for implementation on a LM (e.g., LM 110) through the application of data configuration code 880. In addition to block 880, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 880, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method can be distributed among multiple computers and/or between multiple locations. On the other hand, in this presentation of computing environment 800, detailed discussion is focused on a single computer, specifically computer 801, to keep the presentation as simple as possible. Computer 801 can be located in a cloud, even though it is not shown in a cloud in FIG. 8. On the other hand, computer 801 is not required to be in a cloud except to any extent as can be affirmatively indicated.

PROCESSOR SET 810 includes one, or more, computer processors of any type now known or to be developed in the future. Processing circuitry 820 can be distributed over multiple packages, for example, multiple, coordinated integrated circuit chips. Processing circuitry 820 can implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set can be located “off chip.” In some computing environments, processor set 810 can be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods can be stored in block 880 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory can be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 can be a read only memory (ROM), but typically at least a portion of the persistent storage allows writing of data, deletion of data and re-writing of data. Some familiar forms of persistent storage include magnetic disks and solid-state storage devices. Operating system 822 can take several forms, such as various known proprietary operating systems or open-source Portable Operating System Interface type operating systems that employ a kernel. The code included in block 880 typically includes at least some of the computer code involved in performing the inventive methods.

PERIPHERAL DEVICE SET 814 includes the set of peripheral devices of computer 801. Data communication connections between the peripheral devices and the other components of computer 801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 can include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 can be persistent and/or volatile. In some embodiments, storage 824 can take the form of a quantum computing storage device for storing data in the form of qubits. In embodiments where computer 801 is required to have a large amount of storage (for example, where computer 801 locally stores and manages a large database) then this storage can be provided by peripheral storage devices designed for storing large amounts of data, such as a storage area network (SAN) that is shared by multiple, geographically distributed computers. IoT sensor set 825 is made up of sensors that can be used in Internet of Things applications. For example, one sensor can be a thermometer and another sensor can be a motion detector.

NETWORK MODULE 815 is the collection of computer software, hardware, and firmware that allows computer 801 to communicate with other computers through WAN 802. Network module 815 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801) and can take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 can be a client device, such as thin client, heavy client, mainframe computer and/or desktop computer.

REMOTE SERVER 804 is any computer system that serves at least some data and/or functionality to computer 801. Remote server 804 can be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data can be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs can be stored as images and can be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware and firmware allowing public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the Figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” “data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory operatively coupled to the system, wherein the memory stores computer executable components; and
a processor that executes the computer executable components stored in the memory, wherein the computer executable components comprise:
a dataset configuration component configured to automatically convert a first original dataset to a first modified dataset, wherein the first modified dataset is created in accordance with at least one requirement of a language model (LM), wherein the first modified dataset is utilized to train the LM.

2. The system of claim 1, wherein the dataset configuration component is further configured to apply the first modified dataset to the LM to create a first modified LM.

3. The system of claim 1, wherein the dataset configuration component is further configured to:
identify a license associated with the first original dataset;
determine a scope of the license; and
in the event of the license does not permit use of the first original dataset to train the LM, reject implementation of the first original dataset with the first original dataset.

4. The system of claim 1, wherein the dataset configuration component is further configured to:
format the first original dataset in a tabular format to create the first modified dataset;
identify a first column of data in the first modified dataset as comprising input data, wherein the input data is to be applied to the LM; and
identify a second column of data in the first modified dataset as comprising output data comparable to data output from the LM.

5. The system of claim 1, wherein the dataset configuration component is further configured to:
identify a first collection of data in the first original dataset, wherein the first collection of data has a first language format; and
convert the first collection of data to a second language format, wherein the second language format is a language required to train the LM.

6. The system of claim 1, wherein the dataset configuration component is further configured to:
identify a base data format, wherein the base data format has a structure required for application of data to train the LM;
apply the base data format to the first original dataset; and
format the first original dataset to comply with the base data format.

7. The system of claim 1, wherein the dataset configuration component is further configured to:
identify a first column of data in the first original dataset;
identify a second column of data in the first original dataset; and
compare the content of the first column of data with the content of the second column of data to determine whether:
the first column of data or the second column of data comprises input data; and
the first column of data or the second column of data comprises output data.

8. The system of claim 1, wherein the dataset configuration component is further configured to:
configured to automatically convert a second original dataset to a second modified dataset, wherein the second modified dataset is created in accordance with at least one requirement of the LM, wherein the second modified dataset is utilized to train the LM;
apply the second modified dataset to the LM to create a second modified LM; and
fuse the first modified LM with the second modified LM to form a fused LM, wherein the fused LM comprises a combination of first features present in the first modified LM with second features present in the second modified LM.

9. The system of claim 1, wherein the dataset configuration component is further configured to:
generate a first modified dataset from the first original dataset, wherein the first modified dataset comprises first data from a first column of data in the first original dataset with second data from a second column of data in the first original dataset; and
generate a second modified dataset from the first original dataset, wherein the second modified dataset comprises the first data from the first column of data in the first original dataset with third data from a third column of data in the first original dataset.

10. The system of claim 1, wherein the dataset configuration component is further configured to:
analyze a first original dataset;
determine whether at least a portion of the first original dataset is corrupted data;
discard a first portion of the first original dataset comprising corrupted data; and
retain a second portion of the first original dataset, wherein the second portion of the first original dataset comprises data for implementation in training the LM.

11. A computer-implemented method performed by a device operatively coupled to a processor, wherein the method comprising:
automatically converting a first original dataset to a first modified dataset, wherein the first modified dataset is created in accordance with at least one requirement of a language model (LM), wherein the first modified dataset is utilized to train the LM.

12. The computer-implemented method of claim 11, further comprising applying the first modified dataset to the LM to train the LM and create a first modified LM.

13. The computer-implemented method of claim 11, further comprising:
formatting the first original dataset with a tabular format to create the first modified dataset;
identifying a first column of data in the first modified dataset as comprising input data, wherein the input data is to be applied to the LM; and
identifying a second column of data in the first modified dataset as comprising output data comparable to data output from the LM.

14. The computer-implemented method of claim 11, further comprising:
automatically converting a second original dataset to a second modified dataset, wherein the second modified dataset is created in accordance with at least one requirement of the LM, wherein the second modified dataset is utilized to train the LM;
applying the second modified dataset to the LM to create a second modified LM; and
fusing the first modified LM with the second modified LM to form a fused LM, wherein the fused LM comprises a combination of first features present in the first modified LM with second features present in the second modified LM.

15. The computer-implemented method of claim 11, further comprising:
generating a first modified dataset from the first original dataset, wherein the first modified dataset comprises first data from a first column of data in the first original dataset with second data from a second column of data in the first original dataset; and
generating a second modified dataset from the first original dataset, wherein the second modified dataset comprises the first data from the first column of data in the first original dataset with third data from a third column of data in the first original dataset.

16. A computer program product stored on a non-transitory computer-readable medium and comprising machine-executable instructions, wherein, in response to being executed, the machine-executable instructions cause a machine to perform operations, comprising:
automatically converting a first original dataset to a first modified dataset, wherein the first modified dataset is created in accordance with at least one requirement of a language model (LM), wherein the first modified dataset is utilized to train the LM.

17. The computer program product according to claim 16, wherein the operations further comprise: applying the first modified dataset to the LM to train the LM and create a first modified LM.

18. The computer program product according to claim 16, wherein the operations further comprise:
formatting the first original dataset with a tabular format to create the first modified dataset;
identifying a first column of data in the first modified dataset as comprising input data, wherein the input data is to be applied to the LM; and
identifying a second column of data in the first modified dataset as comprising output data comparable to data output from the LM.

19. The computer program product according to claim 16, wherein the operations further comprise:
automatically converting a second original dataset to a second modified dataset, wherein the second modified dataset is created in accordance with at least one requirement of the LM, wherein the second modified dataset is utilized to train the LM;
applying the second modified dataset to the LM to create a second modified LM; and
fusing the first modified LM with the second modified LM to form a fused LM, wherein the fused LM comprises a combination of first features present in the first modified LM with second features present in the second modified LM.

20. The computer program product according to claim 16, wherein the operations further comprise:
generating a first modified dataset from the first original dataset, wherein the first modified dataset comprises first data from a first column of data in the first original dataset with second data from a second column of data in the first original dataset; and
generating a second modified dataset from the first original dataset, wherein the second modified dataset comprises the first data from the first column of data in the first original dataset with third data from a third column of data in the first original dataset.
